(19) United States
(12) Patent Application Publication
(10) Pub. No.: US 2015/0069830 A1
(43) Pub. Date: Mar. 12, 2015

(54) APPARATUS FOR PARALLEL CONNECTION AND PROTECTION OF BATTERIES OF AN ELECTRIC VEHICLE

(71) Applicant: Shih-Cheng Huang, Kaohsiung (TW)

(72) Inventor: Shih-Cheng Huang, Kaohsiung (TW)

(73) Assignee: ISUDA RECREATION & SPORTS CO., LTD., Kaohsiung (TW)

(21) Appl. No.: 14/368,742

(22) PCT Filed: Dec. 26, 2011
(86) PCT No.: PCT/CN2011/084629

§ 371 Date: Jun. 25, 2014

(51) Int. Cl. H02H 7/18; H02J 1/10

(52) U.S. Cl. CPC H02H 7/18; H02J 1/10; H02J 2001/008
USPC 307/9.1

(57) ABSTRACT

An apparatus for the parallel connection and protection of batteries of an electric vehicle, which comprises a battery unit, a parallel load control and protection unit formed of two diodes connected in parallel, a chip protection unit having two ends thereof respectively electrically connected to the battery unit and the parallel load control and protection unit, and a capacitor unit having two ends thereof respectively electrically connected to the battery unit and the parallel load control and protection unit. The apparatus allows different types of batteries connected in parallel to be used jointly without affecting the characteristics and lifetime of the different batteries, thus can avoid the high cost problem of the conventional techniques caused by applying the battery management systems and prolong the lifetime of batteries and recycle residual electric energy to increase the cruise range of the electric vehicle.

### FIELD OF THE INVENTION

The present invention relates to an apparatus for the parallel connection and protection of batteries, particularly to an apparatus for the parallel connection and protection of batteries enabling an electric vehicle to use different types of batteries.

### BACKGROUND OF THE INVENTION

The electric vehicles available in the market use at least one battery assembly to drive the motor. The battery manufactures use different materials to produce various types of batteries having different characteristics and capacities, including lithium-manganese batteries, lithium-iron batteries, and three-element lithium batteries. However, most of the manufactures of electric vehicles design the electric vehicles to only use a single type of batteries and develop the dedicated protection circuit for the adopted battery. The users may install the batteries of a wrong type or a wrong capacity to their electric vehicles imprudently and damage the circuits. Sometimes, the battery manufacturers may shut down the production of some type of batteries. Therefore, the users of electric vehicles often suffer from difficult maintenance, circuit damage and material shortage.

Lithium batteries feature high energy density and massively apply to high power applications, such as starter batteries, electric bikes, electric motorcycles, and electric automobiles. Refer to FIG. 1. The batteries 11 for an electric vehicle are normally connected in parallel to prolong the power supply time. Sometimes, the batteries of different types, different specifications or different capacities may be connected in parallel imprudently. In such a case, the high-voltage battery 11 may inversely charge the low-voltage battery 11 and thus damage the low-voltage battery 11. While the batteries having different capacities are electrically connected, the internal impedances thereof may cause energy loss and disable the overvoltage, overcharge and overdischarge protections during the current equilibrium process. Further, while the electric vehicle is started or the motor is required to output high dynamic force, the batteries may output uneven or uncontrollable currents, which may lead to sudden unintended acceleration. Therefore, the combination of different types of batteries has a shorter life cycle than the assembly of identical batteries, causing troubles to the user and increasing the maintenance cost of the electric vehicle.

Refer to FIG. 2. The battery manufacturers normally add Battery Management System (BMS) 12 to a module of high-output lithium batteries 11 to enhance the reliability and safety of the system. In fact, all the electric vehicles available in the market have BMS 12 to protect the batteries and circuits.

Even though the lithium-iron batteries, lithium-manganese batteries, lithium-cobalt batteries and three-element lithium batteries respectively adopt different materials as the electrodes and have different full voltage levels, BMS 12 can prevent these batteries 11 lest the service life be shortened and the electric performance be degraded. However, BMS 12 is expensive and occupies a considerable proportion of the whole cost of a lithium battery module. After BMS 12 is used for a period of time, the internal elements thereof may be burned down or short-circuited by high temperature. Thus, the batteries 11 connected with the damaged BMS 12 would be deprived of protection and reduced to a BMS-free state. Further, the other batteries 11 may inversely charge the batteries 11, which are connected with the damaged BMS 11 and deprived of overcharge protection and overdischarge protection. Consequently, the batteries 11 connected with the damaged BMS 12 will be damaged quickly or shut down earlier.

In summary, the conventional BMS 12 has the following disadvantages:
1. As the conventional BMS 12 has a higher price, the user has to pay more money to maintain or repair it.
2. After the conventional BMS 12 is used for a period of time, the internal elements thereof may be burned down or short-circuited by high temperature.
3. The batteries 11 connected with the damaged BMS 12 would be deprived of protection and reduced to a BMS-free state.
4. As the conventional BMS 12 lacks a power recycling device, the electric energy output by the batteries 11 cannot be modified effectively at the instant of starting the electric vehicle, which may lead to sudden unintended acceleration and endanger the driver.
5. The conventional BMS 12 neither has a power recycling device nor has a power interruption mechanism. While the electric vehicle is braking, the electric power is dissipated persistently and wasted unnecessarily.
6. Most of the conventional BMS 12 use the power MOS having three pins. Additional electric power would be spent in the control pin.

### SUMMARY OF THE INVENTION

The primary objective of the present invention is to provide an apparatus for the parallel connection and protection of batteries of an electric vehicle, which comprises a battery unit including at least one battery; a parallel load control and protection unit including two diodes connected in parallel; a capacitor unit electrically connected with the battery unit and the parallel load control and protection unit and including at least one supercapacitor; and a current balance unit including a resistor and an inductor that are connected in series, wherein two sides of the current balance unit are respectively electrically connected with any two batteries of the battery unit.

In order to meet the trend of growing electric vehicle application and support the idea of battery exchange stations, the present invention proposes the apparatus for the parallel connection and protection of batteries of an electric vehicle, which allows the electric vehicle to use different types of batteries simultaneously. The circuit of the present invention can integrate different types of batteries to power an electric vehicle, providing overtemperature, overvoltage, overcharge and overdischarge protections and preventing high-voltage batteries inversely charging low-voltage batteries. The present invention also provides a protection mechanism to turn off the circuit after the circuit is burnt down. The present invention also provides a power recycling mechanism, which recycles the electric power and stores the recycled electric power in a capacitor while the electric vehicle is braking or decelerating, and which supplies the recycled electric power to the electric vehicle while the electric vehicle requires great instantaneous current in starting or accelerating. The present invention can fully utilize the electric energy, reduce burden of the batteries and prolong the service life of the batteries. Further, the present invention can prevent the batteries from being damaged by the short circuit caused by the burned-out battery parallel connection system.

The apparatus for the parallel connection and protection of batteries of an electric vehicle of the present invention comprises a battery unit including at least one battery; a parallel load control and protection unit including two diodes connected in parallel, wherein the diodes may be Schottky diodes; a capacitor unit electrically connected with the battery unit and the parallel load control and protection unit and including at least one supercapacitor; a chip protection unit, which may be a programmable chip, a single chip or a chip including programs; and a current balance unit including a resistor and an inductor that are connected in series, wherein two sides of the current balance unit are respectively electrically connected with any two batteries of the battery unit.

The chip protection unit can be programmed to prevent the battery unit from overcharge or overdischarge and monitor the internal temperature and short-circuit of the battery unit. The chip protection unit is electrically connected with the parallel load control and protection unit and the battery unit and protects the service life and performance of the battery unit via preventing from overcharge, overdischarge, and too high an internal temperature of the battery unit. Further, the chip protection unit monitors whether the battery unit breaks down and whether the parallel load control and protection unit malfunctions to determine whether to alert the user or whether to trigger a standby circuit (not shown in the drawing).

In summary, the present invention has the following advantages:
1. Compared with the conventional BMS using many elements, the parallel load control and protection unit of the present invention only uses two diodes and thus costs less in maintenance.
2. The present invention adopts the Schottky diodes, which tolerate higher voltage and switch bidirectionally faster, and thus can avoid being burned out by high temperature.
3. If the circuit of the diodes is burned out, the circuit would be in an open-circuit state and isolated from the batteries originally connected in parallel with the circuit. Thus, the batteries are still secured.
4. The supercapacitor of the power recycling device of the present invention outputs a great amount of electric energy stored thereinside as the starting current to start the electric vehicle before the batteries output their current and thus prevents the electric vehicle from sudden unintended acceleration. As it only takes few nanoseconds to fully charge the supercapacitor, the supercapacitor can provide a safety mechanism for the user.
5. The conventional BMS neither has a power recycling device nor has a power interruption mechanism. While the electric vehicle is braking, the electric power is dissipated persistently and wasted unnecessarily.
6. Most of the conventional BMS use the power MOS having three pins. Additional electric power would be spent in the control pin.
7. Most of the conventional electronic battery administration systems only use BMS as their protection mechanisms. The present invention further uses a chip protection unit to integrate and monitor the charge process and discharge process of all the battery units. Depending on the programs installed therein, the chip protection unit of the present invention can also display the residual capacity and malfunction of the battery unit, trigger the standby circuit, adjust the circuits, and alert the user of abnormalities. Therefore, the chip protection unit can effectively increase the service life, performance and safety of the parallel connection device of the batteries.

### BRIEF DESCRIPTION OF THE DRAWINGS

FIG. 1 schematically shows a circuit of a conventional battery system of an electric vehicle;

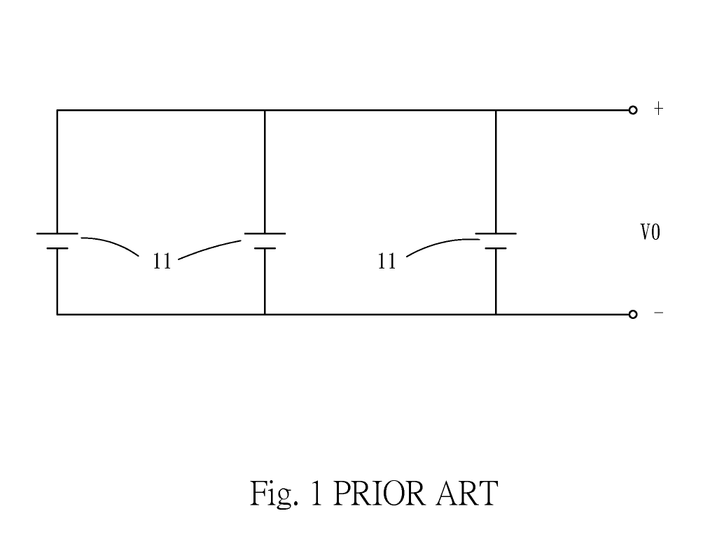

FIG. 2 schematically shows a circuit of another conventional battery system of an electric vehicle;

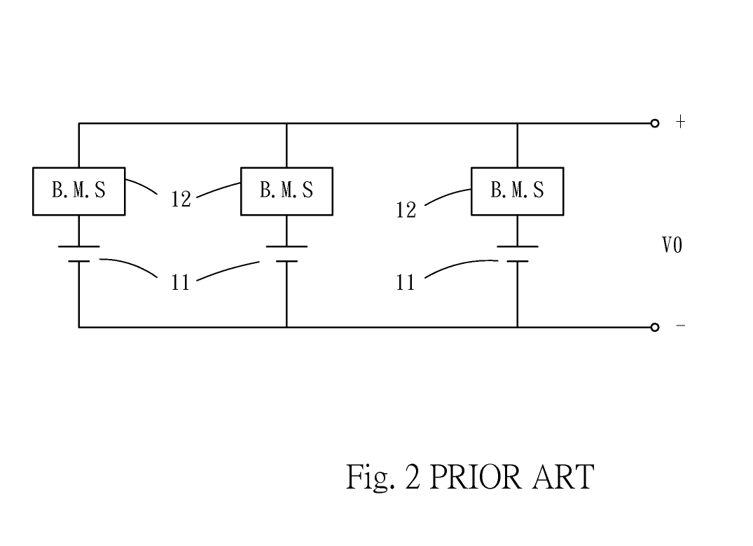

FIG. 3 schematically shows an apparatus for the parallel connection and protection of batteries of an electric vehicle according to a first embodiment of the present invention; and

FIG. 4 schematically shows an apparatus for the parallel connection and protection of batteries of an electric vehicle according to a second embodiment of the present invention.

### DETAILED DESCRIPTION OF THE PREFERRED EMBODIMENTS

Below, the embodiments will be described in detail in cooperation with the attached drawings to fully demonstrate the technical contents, characteristics, and accomplishments of the present invention.

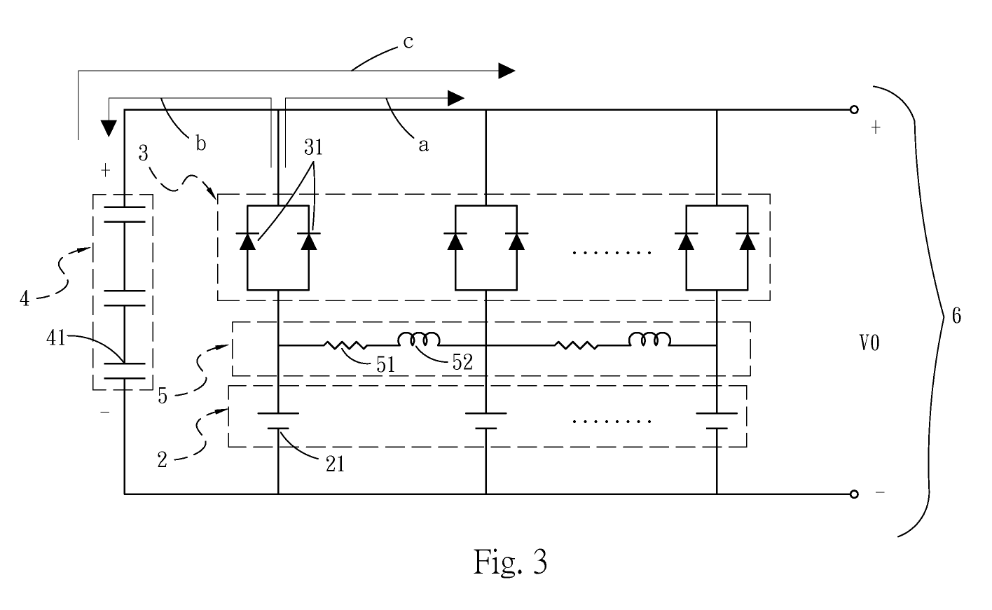

Refer to FIG. 3 schematically showing an apparatus for the parallel connection and protection of batteries of an electric vehicle according to a first embodiment of the present invention. In the first embodiment, the apparatus for the parallel connection and protection of the batteries comprises a battery unit 2 including at least one battery 21; a parallel load control and protection unit 3 including two diodes 31 connected in parallel; a capacitor unit 4 electrically connected with the battery unit 2 and the parallel load control and protection unit 2 and including at least one capacitor 41; and a current balance unit 5 including a resistor 51 and an inductor 52 that are connected in series, wherein two sides of the current balance unit 5 are respectively electrically connected with any two batteries 21 of the battery unit 2.

The current of the battery unit 2 flows through the diodes 31 of the parallel load control and protection unit 3, running along a first current path a and reaching power output terminals 6 to supply electric power to a motor and a motor control circuit (both are not shown in the drawings) for driving an electric vehicle. While the user stops or decelerates the electric vehicle, the power output terminals 6 do not need electric power. In such a case, the current of the battery unit 2 is conducted along a second current path b and stored in the capacitor unit 4 or the battery unit 2 lest the electric energy be wasted. While the user accelerates the electric vehicle from a static or slow-cruise state, the motor needs to output greater dynamic force. In such a case, the motor requires driving by higher starting current to output greater dynamic force. In the present invention, the electric energy stored in the capacitor unit 4 will be conducted along a third current path c to supply a great amount of electric power in a short period of time.

As the capacitor unit 4 can discharge a great amount of electricity in a very short period of time, it is more suitable to start the electric vehicle than the battery unit 2. The specification and quantity of the capacitors 41 of the capacitor unit 4 can be modified to output the required peak power. The capacitor unit 4 can prevent from that too high an instantaneous leads to sudden unintended acceleration and that too low an instantaneous current cannot drive the motor to output the require dynamic force. After the capacitor unit 4 discharges, the batteries 21 of the battery unit 2 take over to provide stable electric power through the parallel load control and protection unit 3. While the battery unit 2 outputs electric power, the residual electric energy will charge the capacitor unit 4. The current balance unit 5 whose two sides are respectively electrically connected with two batteries 21 will balance the currents of the batteries 21.

In one embodiment, the diodes 31 of the parallel load control and protection unit 3 are Schottky diodes. The Schottky diodes can fast switch to synchronize the charge process and the discharge process. The Schottky diodes can endure high voltage. Owing to the high voltage durability, the elements neither likely to have a high temperature nor likely to burn out. Once burned out, the Schottky diodes will be in an open-circuit state, whereby to prevent the batteries 21 from being burned out by abnormal current. The Schottky diodes only allow the current to flow in a single direction and prevent the high-voltage batteries 21 from charging the low-voltage batteries 21, whereby the service life of the batteries 21 is prolonged. The specification of the diodes 31 can be modified to regulate the threshold currents of the batteries 32 and prevent the batteries 21 from overcharge or overdischarge lest the service life of the batteries 21 be shortened.

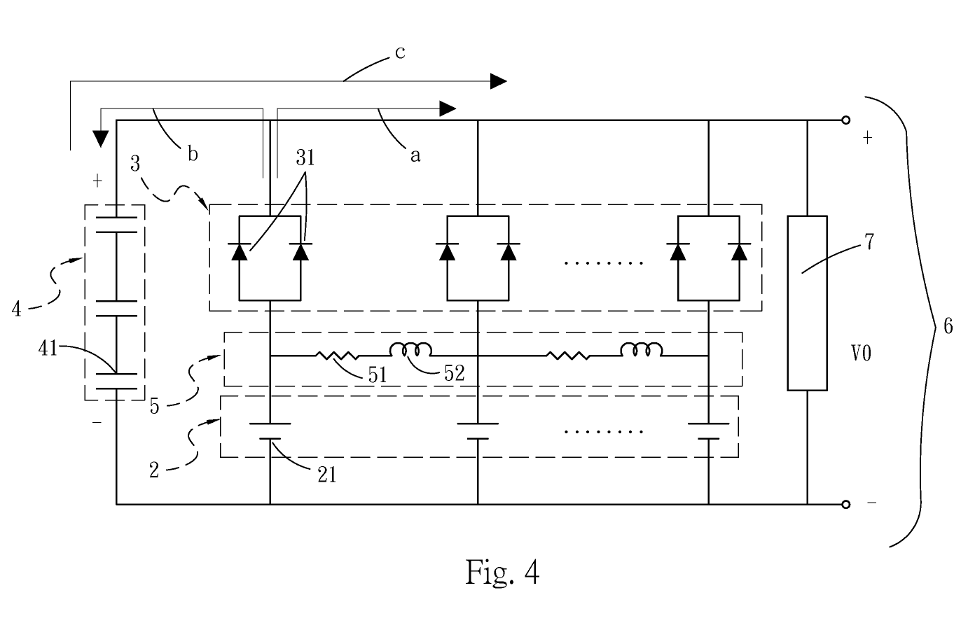

Refer to FIG. 4 schematically showing an apparatus for the parallel connection and protection of batteries of an electric vehicle according to a second embodiment of the present invention. In the second embodiment, the apparatus for the parallel connection and protection of the batteries comprises a battery unit 2 including at least one battery 21; a parallel load control and protection unit 3 including two diodes 31 connected in parallel; a capacitor unit 4 electrically connected with the battery unit 2 and the parallel load control and protection unit 3 and including at least one capacitor 41; a current balance unit 5 including a resistor 51 and an inductor 52 that are connected in series, wherein two sides of the current balance unit 5 are respectively electrically connected with any two batteries 21 of the battery unit 2; and a chip protection unit 7 electrically connected with the battery unit 2 and the parallel load control and protection unit 3.

The power recycling, current balance, and operation of the battery unit 2, parallel load control and protection unit 3 and the capacitor unit 4 has been described above and will not repeat herein. In the second embodiment, the two ends of the chip protection unit 7 are respectively electrically connected with the battery unit 2 and the parallel load control and protection unit 3. In one embodiment, the chip protection unit 7 includes at least one programmable chip, single chip or chip including programs. The chip protection chip 7 has functions of integrating and monitoring the charge process and discharge process of the battery unit 2, detecting the malfunction of the battery unit 2 and the short-circuit of the circuits, triggering the standby circuit (not shown in the drawings), disconnecting the malfunctioning loop, displaying the residual capacity of the battery unit 2, and adjusting the circuits. Therefore, the chip protection unit 7 can effectively increase the service life, performance, and safety of the battery parallel-connection device and fast provide information of errors and problematic sites for the maintenance personnel. Further, the chip protection unit 7 can be programmed to alert the user of abnormalities.

Depending on the programs installed therein, the chip protection chip 7, which is electrically connected with the battery unit 2 and the parallel load control and protection unit 3, can integrate and monitor the charge process and discharge process of the battery unit 2, detect the malfunction of the battery unit 2 and the short-circuit of the circuits, trigger the standby circuit (not shown in the drawings), disconnect the malfunctioning loop, display the residual capacity of the battery unit 2, adjust the circuits, provide information of errors and problematic sites for the maintenance personnel, and alert the user of abnormalities. Thus, the chip protection unit 7 can effectively prolong the service life of the battery parallel-connection device and enhance performance, reliability and safety of the battery parallel-connection device.

Via the abovementioned three mechanisms, the present invention can fully protect the battery unit 2. Via the power recycling mechanism and the capacitor unit 4, the present invention can recycle the residual electric energy and balance the output of the batteries 21 lest instantaneous starting current be insufficient or too great an instantaneous starting current cause sudden unintended acceleration. The present invention further has a chip protection, which can effectively monitor the battery protection device and prevent the battery unit 2 from overcharge or overdischarge and can be programmed by the designer to have functions of alerting the user of abnormalities or triggering a standby control loop.

What is claimed is:

1. An apparatus for the parallel connection and protection of batteries of an electric vehicle, comprising,
a battery unit including at least one battery;
a parallel load control and protection unit including two diodes connected in parallel, and electrically connected with the battery; and
a capacitor unit having two ends respectively electrically connected with the battery unit and the parallel load control and protection unit.

2. The apparatus for the parallel connection and protection of batteries of an electric vehicle according to claim 1, wherein the battery unit includes batteries of different types, or batteries having different capacities, or batteries of an identical type that having different capacities.

3. The apparatus for the parallel connection and protection of batteries of an electric vehicle according to claim 1, wherein the capacitor unit includes at least one capacitor, and wherein the capacitor is a supercapacitor.

4. The apparatus for the parallel connection and protection of batteries of an electric vehicle according to claim 1 further comprising a current balance unit including a resistor and an inductor that are connected in series, wherein two ends of the current balance unit are respectively electrically connected with any two batteries of the battery unit.

5. An apparatus for the parallel connection and protection of batteries of an electric vehicle, comprising
a battery unit including at least one battery;
a parallel load control and protection unit including two diodes connected in parallel, and electrically connected with the battery;
a capacitor unit having two ends respectively electrically connected with the battery unit and the parallel load control and protection unit; and
a chip protection unit including two ends respectively electrically connected with the battery unit and the parallel load control and protection unit.

6. The apparatus for the parallel connection and protection of batteries of an electric vehicle according to claim 5, wherein the chip protection unit is a programmable chip, a single chip or a chip including programs.

7. The apparatus for the parallel connection and protection of batteries of an electric vehicle according to claim 5, wherein the battery unit includes batteries of different types, or batteries having different capacities, or batteries of an identical type that having different capacities.

8. The apparatus for the parallel connection and protection of batteries of an electric vehicle according to claim 5, wherein the capacitor unit includes at least one capacitor, and wherein the capacitor is a supercapacitor.

9. The apparatus for the parallel connection and protection of batteries of an electric vehicle according to claim 5 further comprising a current balance unit including a resistor and an inductor that are connected in series, wherein two ends of the current balance unit are respectively electrically connected with any two batteries of the battery unit.
